(19) United States
(12) Patent Application Publication
(10) Pub. No.: US 2006/0173704 A1
(43) Pub. Date: Aug. 3, 2006

(54) Secure computer system

(75) Inventors: James M. Hair III, Cheyenne, WY (US); Daniel L. Greene, Cheyenne, WY (US)

Correspondence Address: GARDNER CARTON & DOUGLAS LLP;ATTN: PATENT DOCKET DEPT., 191 N. WACKER DRIVE, SUITE 3700, CHICAGO, IL, 60606, US

(73) Assignee: Abet Technologies, LLC, Evanston, IL (US)

(21) Appl. No.: 11/344,836

(22) Filed: Jan. 31, 2006

Related U.S. Application Data
(60) Provisional application No. 60/648,470, filed on Jan. 31, 2005.
(60) Provisional application No. 60/654,010, filed on Feb. 17, 2005.

(51) Int. Cl. G06Q 99/00

(52) U.S. Cl. 705/1

(57) ABSTRACT

A secure computer system is shown and described. The computer system includes (1) a network power controller that has slots and (2) removable cards that are inserted into the slots. The computer system may also include peripheral devices that are coupled to the network power controller through a digital current system. Through the digital current system, the network power controller is able to power and control the peripheral devices remotely. Various embodiments of the disclosed invention provide a computer system that is faster, more reliable, and more secure than conventional systems.

### CROSS-REFERENCE TO RELATED PATENT APPLICATIONS

This patent application claims the benefit of U.S. Provisional Patent Application No. 60/648,470, filed Jan. 31, 2005, and U.S. Provisional Patent Application No. 60/654,010, filed Feb. 17, 2005, both of which are herein incorporated in their entirety by reference.

### FIELD OF THE INVENTION

This invention pertains to a computer system. More particularly, it pertains to a secure computer system in which power and data are transmitted using a single set of wires.

### BACKGROUND OF THE INVENTION

As the number of computer systems connected to the internet and receiving external communications increases, the security of those computer systems has become more important. It is recognized that the single greatest threat to system security is external communications from any other given system. In a conventional computer system, various applications each are allowed to initiate and receive external communications. As a result, computer systems are open to receiving malicious software such as worms, viruses, and spyware. The security of a computer system or computer network is often breached when the data is unknowingly transmitted externally as a result of such malicious software. Firewall software is often used in order to increase the security of computer systems and networks. Firewall software, however, still allows for software control of incoming and outgoing transmissions from various programs on the computer system. Accordingly, a need exists for a computer system that provides hardware controls over external connections and communication.

### BRIEF SUMMARY OF THE INVENTION

In an embodiment, a secure computer system is provided. The computer system includes (1) a network power controller that has slots and a motherboard; and (2) cards that may be inserted into corresponding slots. An application card that contains a software program may be inserted into and removed from an application slot and a master read/write slot.

In another embodiment, the secure computer system includes (1) a network power controller that has slots and a motherboard; (2) a removable network controller card that contains software for operating the network power controller and is inserted into a network controller card slot on the network power controller; (3) a peripheral device that has a peripheral slot in which a removable peripheral card is inserted; and (4) a digital current system that couples the network power controller to the peripheral device.

In an embodiment, a method of securing a computer system is provided. The method includes (1) receiving a file from an external source through a communications card; (2) storing the file on the communications card's memory; (3) disconnecting the communications card from external communications; (4) transferring the file from the communications card's memory to a security card's memory; (5) clearing the communications card's memory; (6) determining whether the file is a security risk; (7) notifying a user that the file is available to be downloaded; (8) detecting whether the user wants to accept the file; (9) transferring the file to a selected application card or memory location; and (10) clearing the security card's memory.

In various embodiments, some advantages of the present invention are increased system speed, reliability, security, and robustness. These and other advantages of the invention will be apparent from the description of the invention provided herein.

### BRIEF DESCRIPTION OF THE DRAWINGS

FIG. 1 is a schematic view of an embodiment of a network power controller according to the present invention.

FIG. 2 is a back view of an embodiment of a network power controller according to the present invention.

FIG. 3 is a schematic view of an embodiment of a master read/write slot according to the present invention.

FIG. 4 is a schematic view of embodiments of an application/peripheral card and an application/peripheral slot according to the present invention.

FIG. 5 is a schematic view of a peripheral device including an application/peripheral slot according to the present invention.

FIG. 6 is a schematic view of embodiments of an application card and an application slot according to the present invention.

FIG. 7 is a schematic view of embodiments of a memory card and an application slot according to the present invention.

FIG. 8 is a schematic view of embodiments of a hard disk drive card and an application slot according to the present invention.

FIG. 9 is a schematic view of embodiments of a communications card and a communications slot according to the present invention.

FIG. 10 is a schematic view of embodiments of a security card and a security slot according to the present invention.

### DETAILED DESCRIPTION OF THE INVENTION

The present invention is generally directed towards a computer system. Various embodiments of the present invention provide a secure computer system that includes a central processing unit and power controller termed the Network Power Controller (the “NPC”), which may be of varying design and capabilities. The NPC is also the central point of supply for the system power and includes a “mother board” or other controlling device to control and operate the entire system. The NPC possesses a plurality of usable “slots” into which preprogrammed cards or other components (e.g., hard drives) may be inserted. These slots may be of various designs and functionality, reflecting their intended use and security levels. An input device such as a keyboard and/or mouse may be coupled to the NPC via a connector assembly that includes appropriate connectors to accommodate a power input, external communications, peripherals, etc.

The computer system also includes a plurality of cards that can be inserted into corresponding slots of the plurality of slots on the NPC. Various components (e.g., flash memory, microprocessors, etc.) on the cards are accessed via physical connections from the NPC to activate and access given locations upon the card itself. Depending on the slot in which the card is inserted, physical contacts will be present that will allow access only to those areas desired (e.g., read-only, read/write, etc.). If a card is inserted in a normal application slot, that portion of the card that is responsible for storing the operating system of the card and on-board application programming for the card would be accessible in a “read-only” physical connection. Additionally, the user memory of the card would be accessible, via a separate physical connection, to the NPC and provides ready access to this memory in a read/write mode. Under normal operation, the card is instantly accessible by the NPC via the card's interface. This allows for immediate loading of applications or files without the delay usually associated with a hard-drive and RAM-based system. The removable cards may be powered in a variety of ways in order to receive and manage appropriate voltage and current levels for efficient operation.

In an embodiment, the secure computer system described herein operates using a power and data infrastructure described in detail in U.S. Pat. No. 6,906,618, issued Jun. 14, 2005, which resulted from U.S. patent application Ser. No. 10/607,230, filed Jun. 26, 2003, both of which are incorporated herein by reference in their entirety.

The patented method and system for bidirectional data and power transmission, which is also referred to as a digital current system, allows for communications and power to be transferred along a common conduit to both power and control given components (nodes) of a computer network. The digital current system has been designed to function with a variety of wires and wire combinations and is capable of operating in an AC environment, a DC environment, or in an environment that combines the two. Various embodiments of a new method and technique for the design and operation of a computer system that makes use of the digital current system are described herein.

While the secure computer system may function in a stand-alone mode, it may also include peripheral devices. Various embodiments of such a computer system are created by combining separate, yet interdependent, components and coupling them together via the digital current system.

In various embodiments of the computer system, the cards may send or receive communications from a central or non-central location within the system using a number of different methods and protocols in order to accomplish their respective designated functions. Examples of possible power and communication methods that may be used by the removable cards include, but are not limited to (a) the digital current system described in U.S. Pat. No. 6,906,618, (b) multiple twisted-pair power lines, (c) printed circuit structures, (d) parallel or serial communications, (e) USB connections, (f) Ethernet connections, (g) 1553 connections, (h) RS 422 connections, (i) RS 485 connections, (j) RS 644 connections, (k) LVDS connections, and (1) multiple voltage power lines (±5 volts, ±12 volts, etc.).

While a variety of power and communications methods may be employed, use of the digital current system to interconnect the system components provides increased advantages over conventional systems. For example, use of the digital current system may increase a system's speed, reliability, security, and robustness. In addition, use of the digital current system also addresses cross-platform compatibility concerns. As long as the NPC and various peripheral devices conform to the digital current system protocols when addressing each other, their internal operations are irrelevant. For example, when the digital current system is used, microprocessors and/or microcontrollers of various platforms or manufacture may be used at different nodes within a single system. Likewise, use of the digital current system allows even opposing operating systems (e.g., MS Dos, Windows, Apple OS, LINUX, UNIX, etc.) to be used simultaneously, without translation, at different nodes. In addition, when the digital current system is employed, the NPC is capable of powering and controlling each peripheral device that is a part of the computer system. Because the NPC can provide power to the peripheral devices, individual power supplies at each peripheral device may be eliminated.

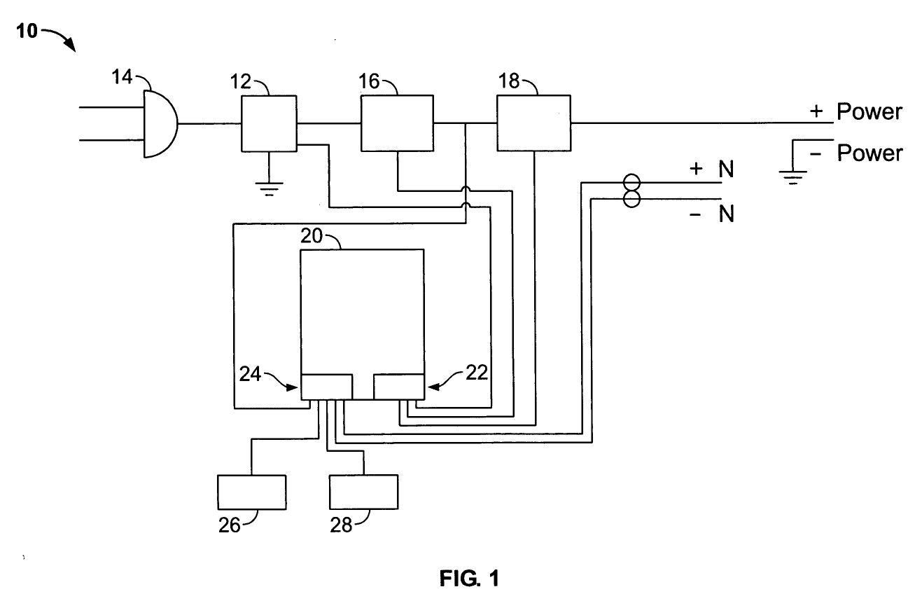

As mentioned above, the “cards” and their corresponding “slots” are designed to accomplish specific functions within the system itself. As shown in FIG. 1, in a possible manifestation of the system, the operating system of the NPC 10 is contained within an embedded card, occupying the NPC's Network Controller Card Slot. This card may be referred to as the NPC Network Controller Card 20. This type of card and slot combination is specifically designed to provide ready access to the read-only portions of the card. Meanwhile, the combination also protects the card from being overwritten because the slot lacks the physical connections to activate or utilize the write function of the card's memory.

The NPC 10 includes a power supply 12 as shown in FIG. 1. The input of the power supply 12 is coupled to an external power source 14. The output of the power supply 12 is coupled to the input of a current sense monitor 16. The output of the current sense monitor 16 is coupled to a system power control 18. The output of the system power control provides +Power and −Power (Ground) to the computer system. The power supply 12 and current sense monitor 16 are coupled to a Network Controller Card 20 via the system power interface 22. The Network Controller Card 20 also contains a digital current system interface 24. The digital current system interface 24 is coupled to the current sense monitor 16 output, the system power control 18 input, and the digital current system communications connections (+N and −N). The digital current system interface 24 is also coupled to a system power indicator 26 and a system activity indicator 28. The Network Controller Card Slot comprises connections that correspond to the digital current system interface 24 and the system power interface 22.

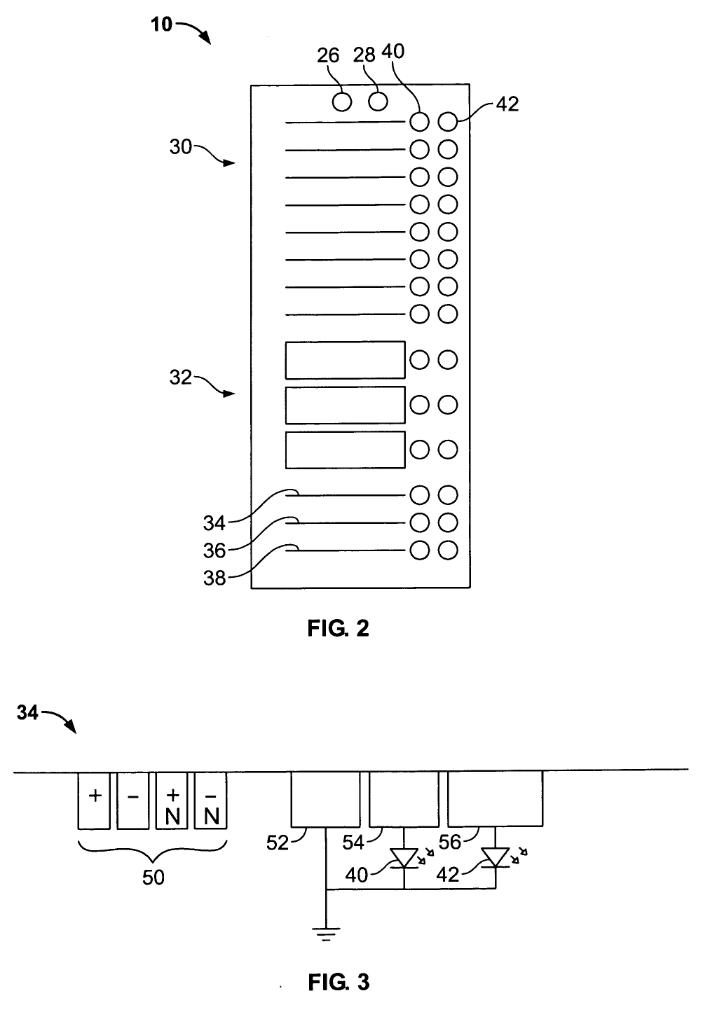

The NPC 10 includes a plurality of slots for receiving a plurality of cards. In an embodiment, the plurality of slots may include Application Card Slots 30, Special Application Slots 32, a NPC Master Read/Write Slot 34, a Security Card Slot 36, and a Communications Card Slot 38, as shown in FIG. 2. As discussed with reference to the Network Controller Card's 20 digital current system interface 24, the NPC 10 also may include a system power indicator 26 and a system activity indicator 28. A plurality of card power indicators 40 and a plurality of card activity indicators 42 may also be included in the NPC 10. A Network Controller Card Slot for the Network Controller Card 20 may be located on the back of the NPC 10 along with the other card slots or may be located in a remote location such as on the side of the NPC 10.

In an embodiment, the individual cards are initialized prior to use with the NPC 10. During such initialization of a given card, the card is installed or inserted into a Master Read/Write Slot 34 for identification, verification, and formatting prior to insertion into a working Applications slot. An embodiment of a Master Read/Write Slot 34 will now be discussed with reference to FIG. 3. The Master Read/Write Slot 34 includes a digital current system interface 50 for coupling an inserted card with the digital current system's communications (+N and −N) and power connections (+Power and −Power) portions. The Master Read/Write Slot 34 also includes the physical connections necessary to access any given card's Operating System or Application System Flash Memory. This physical connection is represented by the Application Write-Enable Pin 52, which establishes a connection between the NPC and a given card by activating the Application Write-Enable function of a card. In an embodiment of the computer system, this is the only slot that possesses the Application Write-Enable Pin 52. In an embodiment, this slot is not intended for constant use and lacks the physical connections to allow a given card to perform its programmed function. The Master Read/Write Slot 34 also contains a power ok indicator connector 54 and an activity indicator connector 56. These indicator connectors 54, 56 are coupled to their corresponding indicators from the pluralities of card power indicators 40 and card activity indicators 42.

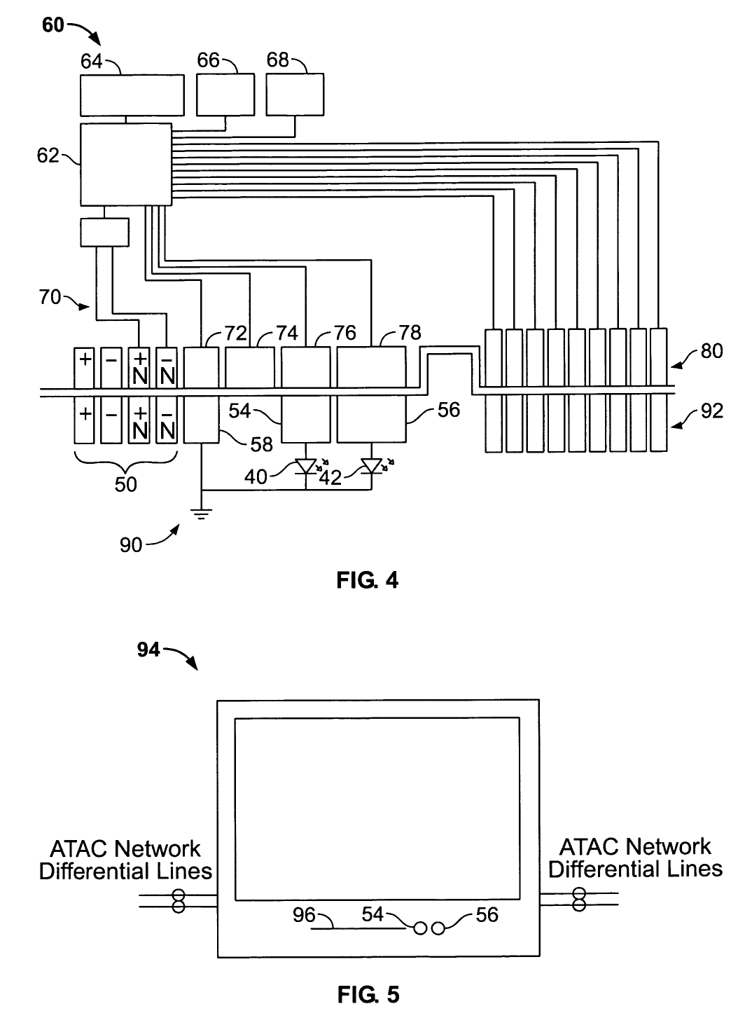

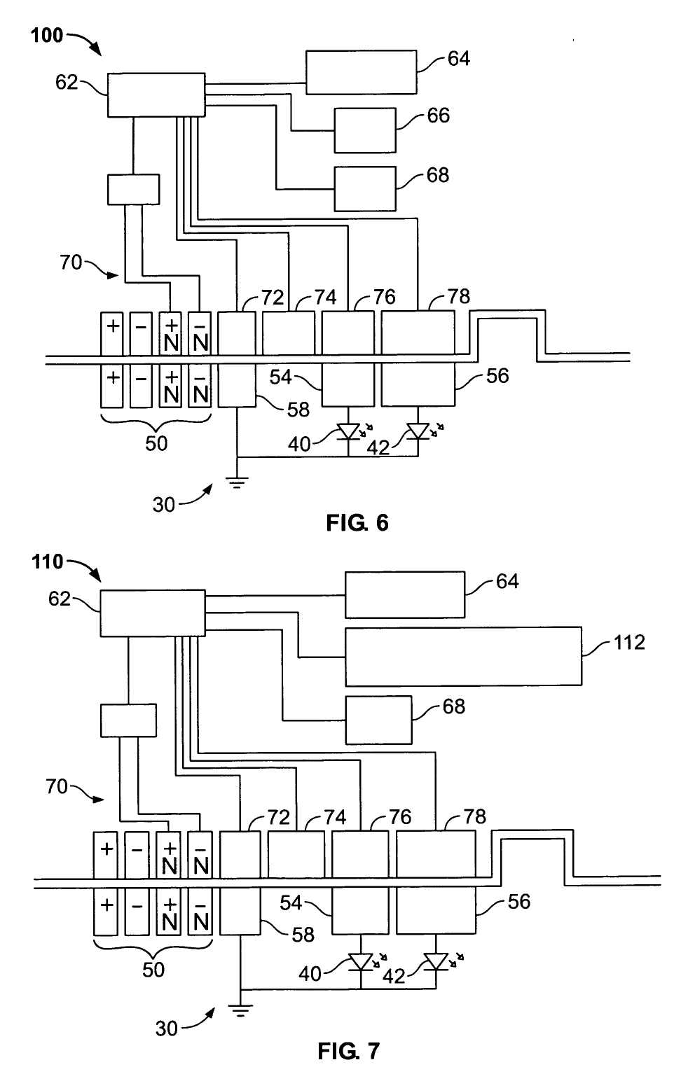

Initialization through the Master Read/Write Slot 34 may be accomplished in several ways. One way of initializing the card includes the following steps. A pre-programmed Application Card 100 (see FIG. 6) with an embedded operating system is inserted into a given computer system's NPC Master Read/Write Slot 34. An embodiment of such a pre-programmed card is shown in the upper portion of FIG. 6. The NPC 10 then accesses the Application Flash Memory 64 (see FIG. 6), searches for acceptable encryptions from a given software manufacturer/designer/vendor that identify it as a legitimate card and identifies the card's intended design function (e.g., graphics/monitor, printer, user application, etc.). Once verified, the card is assigned a randomly-generated alpha-numeric address identification, known only to that particular NPC 10 and the card in question. During this operation, other variable options may be accomplished and installed within the operating system of the card. These could include passwords, security levels, computer/user identifications, etc. Once the card is initialized and provided with a unique, discrete address, the card is removed from the Master Read/Write Slot 34 and installed in an appropriate Application Slot 30 (see FIG. 6) or Application/Peripheral Slot 90 (see FIG. 4) in order to be used.

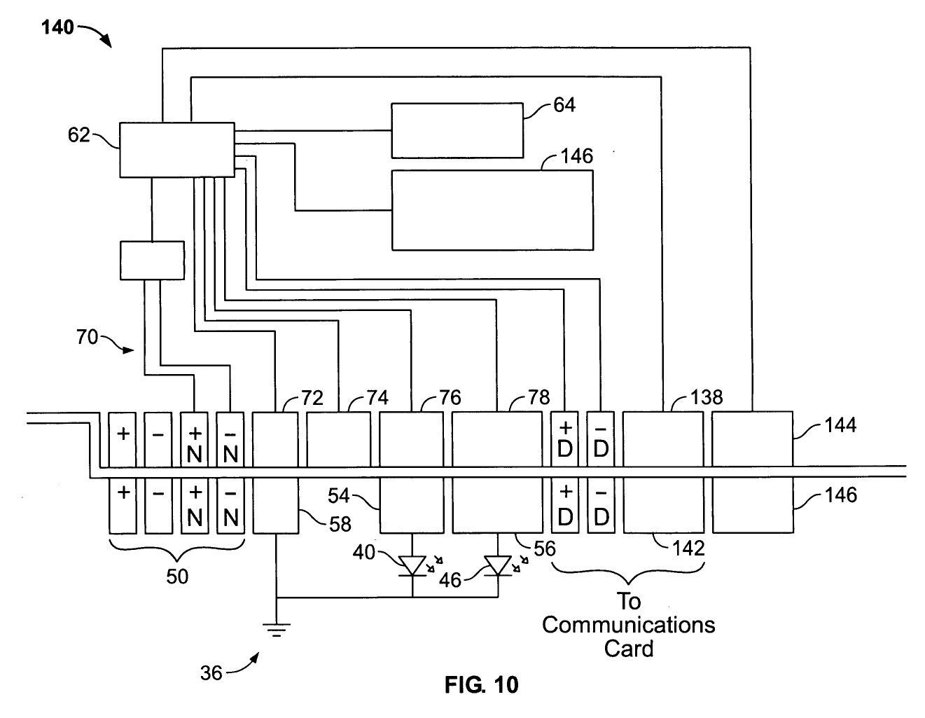

Embodiments of additional cards and slots will now be described with reference to FIGS. 1-10.

As discussed above with reference to FIG. 1, a Network Controller Card 20 contains all of the operating system information necessary to efficiently operate the entire NPC 10 and manage the operation of all other cards (peripheral, application, memory, etc.). The Network Controller Card 20 is provided and installed into a Network Controller Card Slot on the NPC 10 by the manufacturer prior to the card's first use. The card may be installed in a semi-inaccessible location to prevent tampering.

Another type of card, the Application/Peripheral Card 60, will now be discussed with reference to FIG. 4. The application or operating system programming on any given card is only accessible in a read-only mode during normal operation of the system, and the Application/Peripheral Card Slot 90 into which it is fitted lacks the physical connections necessary to access these portions in a read-write mode. The Application/Peripheral Card 60 includes an embedded microcontroller 62, Application Flash Memory 64, File Flash Memory 66, and File Random-Access (RAM) Memory 68 to accommodate the programming and memory necessary for the card to accomplish its given design function. It also includes a digital current system interface 70 for coupling the card to the digital current system's communications (+N and −N differential communications lines) and power connections (+Power and −Power) portions. The Application/Peripheral Card 60 also contains an Application Enable Connector 72, an Application Write Enable Connector 74, a Power OK LED Connector 76, and an Activity LED Connector 78. The Power OK and Activity LED Connectors 76, 78 are coupled to card power and activity indicator connectors 54, 56 on corresponding slots. As will be further discussed below, the Application/Peripheral Card 60 may be inserted into an Application/Peripheral Slot 90 on a plurality of components and peripherals (e.g., keyboards, monitors, printers, etc.). The Application/Peripheral Card 60 also includes a plurality of miscellaneous pins 80 for sensing and controlling off-card operations (e.g., keyboards, remote sensors, mouse, cameras, etc.).

In the event that the operating system must be modified or upgraded in any way, several methods of accomplishing an upgrade to this unit may be followed, depending on the level of security required. For example, in a high security, administrator-managed environment, the card in question could be removed and reprogrammed using the administrator's computer or laptop. In a low security environment, a “blank” operating system Application/Peripheral Card 60 could be inserted in that particular NPC's Master Read/Write Slot 34. The existing operating system, with all its pertinent information could then be copied directly into the new card and stored upgrades from a communication/security buffer could then be imported. Alternatively, a vendor may just wish to provide a new upgraded card to replace an existing one. In this case, the new card would again be inserted in the NPC's Master Read/Write Slot 34 and pertinent system information would be stored prior to the new card's installation.

An example of a standard Application/Peripheral Slot 90 is illustrated in the lower portion of FIG. 4. The standard Application/Peripheral Slot 90 is utilized during the normal operation of the Application or Peripheral Cards of the system. This type of slot possesses the digital current system interface 50 necessary to power a matching card via the digital current system (Power+ and Power−) and to provide communications connections with the digital current system (+N and −N). Additionally, the card's Application Enable function is powered and controlled via the slot's corresponding Application Enable connection 58. In order to monitor a given card's proper placement and operation, two indicator LEDs 40, 42 are also provided and are powered via connections to the digital current system power. The LEDs'connections, which interface with their corresponding counterparts on an individual Peripheral Card or Application Card 60, are known as the Power OK LED connection 54 and the Activity LED connection 56. Additionally, this type of slot may possess a plurality of miscellaneous interface connections 92, corresponding to matching elements on an inserted card, to provide additional connections to the off-card environment. This category of slot, however, lacks the physical connection needed to activate the write function of the Application Write Enable 74 on an Application/Peripheral Card 60. Therefore, while the slot may provide the physical connection and ability for the user to access the card's File Ram 68 component for user storage or use, changes to the card's Operating System and Application Programming (contained within the Application Flash Memory 64) cannot be accomplished due to the lack of this physical pin. This type of slot can be connected to the NPC 10 either as a built-in array or as a separate, stand-alone component.

Additionally, the Application/Peripheral Slot 90 may be installed as a component on a plurality of peripherals or components such as monitors, printers, scanners, etc. For example, as shown in FIG. 5, an Application/Peripheral Slot 90 may be provided on a monitor 94. In this case, it may be referred to as a Monitor Application Slot 96 because it receives a Monitor Application Card. The Power ON LED 40 and the Activity LED 42 are shown on the front of the monitor 94 of FIG. 5. In addition, as shown in FIG. 5, the monitor 94 is coupled to the NPC 10 via the digital current system's differential lines (+N and −N).

In this type of application, the component in question would be directly controlled by its constituent card via its corresponding slot. This type of operation may allow for complex programming (e.g., exotic graphics, high quality sound, printer options and diagnostics, etc.) to be located within the component itself instead of in the NPC 10. This capability allows for a decrease in the requirement for high-speed communications with the CPU (NPC 10) and provides the capability of a distributed intelligence system to the entire system itself. Another advantage of this type of distributed intelligence system is that, as described above, each of the individual component's cards will receive a discrete, randomly-generated, alpha-numeric address identification during its initial system programming. This confidential address is then only accessible to the NPC 10, which knows the individual address, and does not allow any outside source to send any information to any discrete or constituent address or component. Accordingly, this capability of the system severely limits the ability of outside forces to affect or control the components of any given system.

Another example of a card is an Application Card 100, as shown in FIG. 6. Application Cards 100 are normally devoted strictly to an application program and are provided by a vendor. Blank cards of this type also could be made available for individual users/programmers. The major difference between the Application Card 100 and the Application/Peripheral Card 60 is that the Application Card 100 lacks the miscellaneous pin connections 80 found on the Application/Peripheral Card 60 since such controlling connections are not required on a card containing a standard application (e.g., word processing, spread sheet, CAD, etc.). The Application Card 100 contains all of the other components and connections that the Application/Peripheral Card 60 contains.

As shown in FIG. 6, the Application Card 100 may be inserted into an Application Card Slot 30. The Application Card Slot 30 lacks the miscellaneous pin connections 92 that are found on the Application/Peripheral Card Slot 90. The Application Slot 30 contains all of the other components and connections that the Application/Peripheral Card Slot 90 contains.

Another example of a card is a Memory Card, as shown in the upper half of FIG. 7. Like the other cards, the Memory Card 110 includes an embedded microcontroller 62, Application Flash Memory 64, and File Random-Access (RAM) Memory 68 to accommodate the programming and memory necessary for the card to accomplish its given design function. Unlike the other cards, however, it includes Large File Flash Memory 112 instead of File Flash Memory 66. As shown in FIG. 7, the Memory Card 110 otherwise includes the same connectors as the other cards. Memory Cards 110 normally are devoted to providing a large, user-accessible file storage area for a given NPC 10. In essence, this type of card would be performing the same function as a removable floppy disk or zip drive, or a removable hard drive, depending on the amount of memory provided or required. As with the other cards, this type of card is “formatted” in the NPC's Master Read/Write Slot 34 to receive security, address, system, and other imbedded information prior to insertion into a given Application Slot 30. In an embodiment, as a security feature, failure to accomplish this type of formatting will result in the card being unusable in the computer system.

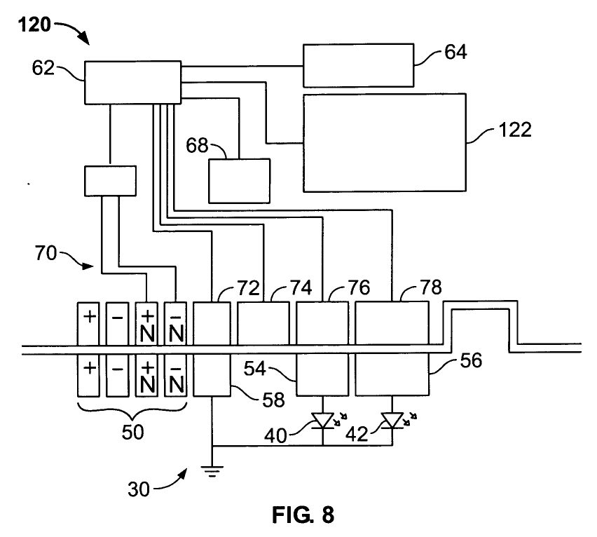

Still another example of a card is a Hard Disk Drive Card 120, as shown in FIG. 8. This special type of card is a constituent component of a discrete traditional Hard Disk Drive. This hybrid component is inserted into a Special Application Slot 32, as shown in FIG. 2, and allows the user access to the traditional hard disk drive as a file storage area. In an embodiment, the Special Application Slot 32 is larger than a standard Application Slot 30 so that it can accommodate larger components. Like the other cards, the Hard Disk Drive Card 120 includes an embedded microcontroller 62, Application Flash Memory 64, and File Random-Access (RAM) Memory 68 to accommodate the programming and memory necessary for the card to accomplish its given design function. Unlike the other cards, however, it includes a Large Disk Drive 122 instead of File Flash Memory 66. As shown in FIG. 8, the Hard Disk Drive Card 120 otherwise includes the same connectors as the other cards. As with the other cards, this card is inserted into a given NPC's Master Read/Write Slot 34 to be preprogrammed (formatted) with the appropriate security, address, system, and other imbedded information prior to installation and use.

As discussed above, external communications from other systems are a threat to conventional computer systems. In the disclosed computer system, the Communications Card 130 and Security Card 140 (described below) work together to protect the system from such a threat. The Communications Card 130, once properly formatted on a given NPC 10, is installed in a special Communications Slot 38, which is further discussed below. In an embodiment, physical characteristics on both the card and its corresponding slot make it impossible to insert this card into any other type of slot, other than the NPC's Master Read/Write Slot 34. As with the other cards, the Communications Card 130 is inserted into a given NPC's Master Read/Write Slot 34 and formatted with appropriate security, address, system, and other imbedded information prior to installation and use.

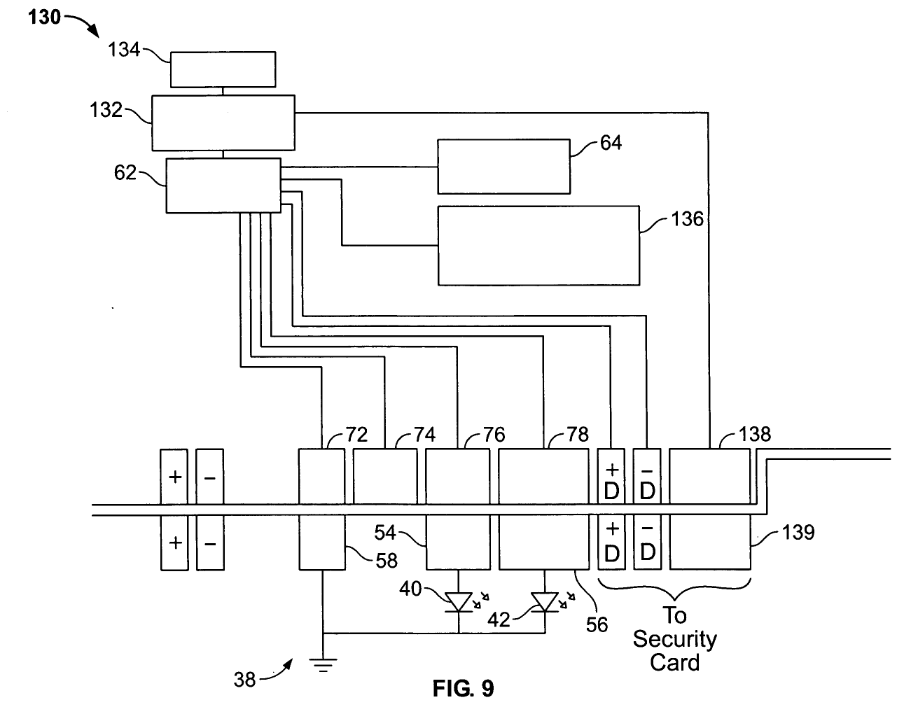

An embodiment of a Communications Card 130 and an embodiment of a corresponding Communications Slot 38 will now be discussed with reference to FIG. 9. The Communications Slot 38 includes power connections (Power+ and Power−) necessary to power a Communications Card 130 from the digital current system. The Communications Slot 38 includes an Application Enable connection 58, which is coupled to the Communication Card's 130 Application Enable connection 72 for powering and controlling the Communication Card's 130 application enable function. The Power OK LED connection 54 and the Activity LED connection 56, as discussed above, are included within the Communications Slot 38 for interfacing with the Communication Card's 130 Power OK LED and Activity LED connections 76, 78. Unlike the Master Read/Write Slot 34, the Communications Slot 38 lacks the physical connection needed to activate the write function of the card's Application Write Enable. Therefore, changes to the card's Operating System and Application Programming (contained within the Application Flash Memory 64) cannot be accomplished due to the lack of this physical pin.

To enhance the security of the Communications Card 130, embodiments of the Communications Card 130 and Communications Slot 38 may include the following physical characteristics. First, the external communications capability of the card (+D and −D) is isolated in a discrete location from which the card can only send communications directly to the Security Card 140, which is further discussed below. The Communications Card is also coupled to the Security Card 140 via a Communications Connector 138. The Communications Connector 138 on the Communications Card 130 corresponds to a Communications Connector 139 on the Communications Slot 38. Second, the Communications Card 130 possesses a communications control switch 132 to external sources 134 (e.g., the internet), and this switch 132 renders the computer inaccessible during normal operation, unless overridden by the Security Card 140. Third, the embedded microcontroller 62 and associated software allows physical connections to only the Security Card 140, a system monitor, and input devices (e.g., keyboard and/or mouse). No other components or cards have a communications capability with the Communications Card 130 except via the Security Card 140. Fourth, as an added security measure, when the Communications Card's Communication RAM 136 receives a file for transfer, such a file is held in the Communications RAM 136 only long enough to transfer to the Security Card 140 for further actions. The Communications Card Communication RAM 136 is blanked following such a transfer. Finally, to further enhance the security of the system as a whole, the Communications Card 130 does not possess the physical connections necessary to talk via the digital current system directly (+N and −N). All communications from and to the Communications Card 130 must be orchestrated and controlled by the Security Card 140.

In a possible manifestation of the Communications Card 130, a specific application (e.g., an interactive, internet game, or conference program) could be inserted into the Communication Slot 38, replacing the existing Communications Card 130 temporarily. Such a card would then be controllable via the Security Card 140 by the keyboard/mouse and accessible to the system monitor. This would allow the user to interact with the card directly (e.g., in playing an internet game or participating in an internet conference) without constantly enabling the Security Card 140 while still maintaining the isolation of the computer system as a whole. This card would still lack the physical ability to communicate with the system except via the Security Card 140 and would conceivably contain all of the programming, RAM, and flash as well as embedded controllers, components, and other memory necessary to properly run the application independently and without committing system resources. The card, however, is controllable via the security card, which provides enhanced security by isolating the system and allowing access only to the keyboard/mouse and monitor.

In an embodiment of the computer system, the above-described installation of an application-specific Communications Card 130 is an exception to the usual practice of inserting any constituent card into the NPC's Master Read/Write Slot 34 for formatting. Since this type of card is considered a “temporary add-on” for a specific purpose and is not a long-term component of the system, the card does not require encoding, addressing, or other information to be placed upon it since it shall not become a part of the system itself.

An embodiment of the Security Card 140 discussed above will now be described with reference to FIG. 6. The Security Card 140 acts as an intelligent/physical barrier or firewall and buffer between the system (excluding the Communications Card 130) and all external communications. The Security Card includes the standard card connectors, excluding the Application Write Enable Connector, and also includes connectors for communicating with the Communication Card 130 via +D and −D, a Communications Connector 138, and a Transfer File Control Connector 142. The Security Slot 36 into which the Security Card 140 is inserted contains the standard slot connectors in addition to connectors that correspond to the Security Card's 140 special connectors. The +D and −D connectors on the Security Card 140 correspond to +D and −D connectors on the Security Slot 36 for coupling the Security Card 140 to the Communications Card 130. The Communications Connector 138 on the Security Card 140 corresponds to a Communications Connector 142 on the Security Slot 36. The Transfer File Control 144 on the Security Card 140 corresponds to a Keyboard Switch Connector 146 on the Security Slot 36.

In operation, external communications received by the Communications Card 130 are first stored in the Communications RAM 136. Outside communications are then terminated by the Security Card 140 and the file(s) held within the Communications Card's Communications RAM 136 are transferred to the Security Card's Security RAM 146. There, such files are scanned against preprogrammed profiles that correspond to virus, worm, Trojan Horse, adware, spyware, or other executable files and are “cleared” prior to being released to the system in general. In an embodiment, if a file possesses unwanted components, the file is deleted from the system and the user is notified that the file was deleted because it contained a virus.

The present invention also includes a method for securing a computer system. An embodiment of this method will now be described.

In the case that legitimate executable programs are to be downloaded (e.g., upgrades for word processing programs, spreadsheet programs, etc.), such programs go through an interactive process to be allowed. An example of one such process includes the following steps. First, the Communications Card 130 receives notification of an upgrade or receives the upgrade itself. The notification or upgrade is stored in the Communications Card's Communications RAM 136. After the transfer to the Communications RAM area 136 occurs, the Security Card 140 disconnects the Communications Card 130 from all external communications. The Security Card 140 then causes the Communications RAM 136 to transfer its contents to the Security Card's Security RAM 146 area and then clear itself. The Security Card 140, via its stored definitions, then scans the file for known contaminants and/or proprietary encryptions. The Security Card 140 then may reestablish outside communications with a given vendor to verify the authenticity of the file. To do so, the Security Card 140 will transfer to the Communications Card 130 any information to be externally transmitted. The Communications Card 130 will then open communication channels to sources outside the system and may send or download files while acting as a buffer between the security card and the external sources. The Security Card 140 then notifies the user, via the monitor, that a “safe” download or upgrade is being held in the Security RAM 146 for installation. The user then has the ability to review the upgrade and decide if such an action is warranted. If the user does not want to upgrade the file, it is generally deleted but could instead be recorded to a storage location such as a Memory Card 110 or Hard Disk Drive Card 120 for later upgrade, although the file would not be executed directly from such a storage location. If the user determines that he or she wishes to upgrade or modify the application, he or she removes the applicable Application Card 30 from its slot (if it is inserted), inserts the card into the NPC's Master Read/Write Slot 34, and depresses the TRANSFER key. (In an embodiment, the TRANSFER key is a physical connection to the Security Card 140 that must be manually depressed or activated for each transfer action. In such an embodiment, this function cannot be duplicated via programming and must be accomplished via the action of the user. In an embodiment, the TRANSFER key is located on a keyboard. In other embodiments, the TRANSFER key is located elsewhere. For example, it may be an external connection that only a system administrator has control over or it may be located on the NPC 10, e.g., next to the Master Read/Write Slot 34. In response, the Security Card 140 transfers the new information to the applicable Application Card 30, clears the Security RAM 146, and informs the user, via the monitor, that the requested actions have been accomplished. The user may then reinstall the Application Card 30 into a compatible slot for use. Referring to the system administrator control mentioned above, in high-security or sensitive applications, it is possible that no upgrades or modifications, regardless of their source, may be downloaded to an Application Card 30 without a pre-established administrator password or other encryption. Such a limitation may be pre-programmed by the administrator during system setup.

In the event that individual files, other than operating system or application updates or upgrades, need to be transmitted or received (e.g., documents, spreadsheets, pictures, etc.) a similar interactive process is used. An example of such a process includes the following steps. The Communications Card 130 receives notification of an incoming file and the incoming file and stores the incoming file in the Communications RAM 136. After transfer to the Communications RAM 136 area has occurred, the Security Card 140 causes the Communication Card 130 to disconnect from all external communications. The Security Card 130 then causes the Communications RAM 136 to transfer its contents to the Security Card's Security RAM 146 area and clear itself. The Security Card 140, via its stored definitions, scans the file(s) for known contaminants and identifies the type of file (e.g., word processing, spreadsheet, JPEG, etc.). Additionally, the file's history (e.g., author, source, date of origin, computer or system of origin, etc.) may also be established at this time. The Security Card 140 then may reestablish communications with the sending entity to ensure that the file has been received complete and in good order. The Security Card 140 then notifies the user, via the monitor, that a “safe” file is being held in the Security RAM 146 for transfer. The user then has the ability to review the file and decide if he or she wishes to download it into the system. If the user decides not to download the file, the file is handled as described above. If the user determines that he or she wishes to download such a file, he or she first selects an accessible memory location for the file to be written into and then depresses the TRANSFER key. The Security Card 140 then transfers the selected file(s) to the desired memory location, clears the Security RAM 146, and informs the user, via the monitor, that the requested actions have been accomplished. In an embodiment, this file transfer operation only allows for non-executable files; therefore, system or application specific files should be transferred as described in the previous paragraph and may not be transferred via this method. Referring to the system administrator control mentioned above, in high-security or sensitive applications, it is possible that no files, regardless of their source, may be downloaded to any memory location without a pre-established administrator password or other encryption. Such a limitation may be pre-programmed by the administrator during system setup.

An embodiment of the method for securing a computer system also includes a secure method for uploading or sending individual files. An example of the method includes the following steps. The user first selects a file (e.g., document, spreadsheet, picture, etc.) and then selects a “send” option from a menu. The selected file(s) are then copied to the Security RAM 146 portion of the Security Card 140. At this time, the file(s) may be “tagged” with various identifying information, including author, date of origin, date of transfer, computer identification, necessary encryptions, etc. The Security Card 140 then notifies the user that the file(s) are ready for transfer. The user then depresses the TRANSFER key for the file(s) to be moved to the Communications RAM 136 area for transmission. The Communications Card 130 then establishes contact with the desired location and causes the file(s) to be transferred. The Communications Card 130 then waits for a confirmation of delivery in an “idle” mode. Upon completion of the transmission, the Communications Card 130 clears its Communications RAM 136 and awaits further instructions.

In all of the above steps for communications, uploads, downloads, etc., a running log of activity from the Security Card 140 may be stored in any number of memory locations within the system for information, security, and design considerations. This log may include information related to file names, times, problems encountered, and any other pertinent information.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. A computer system, the system comprising:
a network power controller, the network power controller comprising a motherboard and a plurality of slots, wherein the plurality of slots comprises a network controller card slot and a master read/write slot; and
a plurality of cards, each of which is removably disposed in a corresponding slot of the plurality of slots, the plurality of cards comprising a network controller card that contains a software program.

2. The computer system of claim 1, wherein the plurality of slots further comprises a communications slot and a security slot and wherein the plurality of cards further comprises a communications card that receives and sends external communications and a security card that isolates the network power controller from external communications.

3. The computer system of claim 1, wherein the network power controller controls and powers the plurality of cards via a digital current system.

4. The computer system of claim 1, wherein the network power controller controls a peripheral device via a digital current system.

5. The computer system of claim 1, further comprising:
a user input device; and
a connector assembly for coupling the user input device to the network power controller.

6. The computer system of claim 2, wherein the security card isolates the network power controller from external communications by blocking a transmission to or from the system unless the transmission is manually authorized by a user in response to a notification regarding the transmission.

7. The computer system of claim 2, wherein the communications card has a first storage area and the security card has a second storage area, and wherein the security card performs steps comprising:
in response to detecting a received file stored within the first storage area, disconnecting the communications card from external communications;
storing the received file in the second storage area;
scanning the received file;
notifying a user that the received file is being held in the second storage area; and
in response to receiving a user input, transferring the received file to a memory location.

8. The computer system of claim 7, wherein, after the communications card has been disconnected from external communications, the security card directs the communications card to first transfer the received file to the second storage area and then remove the received file from the first storage area.

9. The computer system of claim 1, wherein the network controller card comprises an application memory area for storing the software program, and wherein the software program comprises instructions for operating the network power controller, and wherein among the slots of the plurality of slots, only the master read/write slot includes physical connections for writing to the application memory area.

10. The computer system of claim 1, wherein the plurality of cards includes a peripheral application card that contains information for operating a peripheral device, and the plurality of slots includes a peripheral application slot in which the peripheral application card is removably disposed.

11. The computer system of claim 1, wherein the plurality of cards includes an application card that contains application software, and the plurality of slots includes an application slot in which the application card is removably disposed.

12. A computer system, the system comprising:
a network power controller, wherein the network power controller comprises a motherboard and a plurality of slots comprising a master read/write slot and a network controller card slot;
a network controller card that contains software for operating the network power controller, wherein the network controller card is removably disposed in the network controller slot;
a peripheral device, wherein the peripheral device comprises a peripheral card removably disposed in a peripheral slot of the peripheral device; and
a digital current system that couples the network power controller to the peripheral device.

13. The computer system of claim 12, wherein the peripheral card comprises:
a processor for controlling the operation of the peripheral card;
memory for storing operating programs and data, wherein the memory is coupled to the processor;
a pin for sensing and controlling off-card operations, wherein the pin is coupled to the processor; and
an interface for the bidirectional digital current and power system, wherein the interface is coupled to the processor.

14. The computer system of claim 12, further comprising an application card that contains application software, and wherein the plurality of slots includes an application slot in which the application card is removably disposed.

15. The computer system of claim 12, further comprising:
a communications card having a first storage area, wherein the communications card is removably disposed in a communications slot of the plurality of slots of the network power controller; and
a security card for isolating the network power controller from external communications, wherein the security card the security card has a second storage area and is removably disposed in a security slot of the plurality of slots of the network power controller, and wherein the security card performs steps comprising:
in response to detecting a received file stored within the first storage area, disconnecting the communications card from external communications;
storing the received file in the second storage area;
scanning the received file;
notifying a user that the received file is being held in the second storage area; and
in response to receiving a user input, transferring the received file to a memory location.

16. The computer system of claim 12, further comprising:
a communications card having a first storage area, wherein the communications card is removably disposed in a communications slot of the plurality of slots of the network power controller; and
a security card for isolating the network power controller from external communications, wherein the security card the security card has a second storage area and is removably disposed in a security slot of the plurality of slots of the network power controller, and wherein the security card performs steps comprising:
in response to detecting a received program stored within the first storage area, disconnecting the communications card from external communications;
storing the received program in the second storage area;
scanning the received program;
notifying a user that the received program is being held in the second storage area; and
in response to receiving a user input, transferring the received program to an application card removably disposed within the master read/write slot.

17. The system of claim 12, wherein the peripheral device is a sensor.

18. The system of claim 12, wherein the peripheral device is a computer.

19. A method of securing a computer system, the method comprising:
receiving a file from an external source via a communications card;
storing the file in a first storage area on the communications card;
disconnecting the communications card from external communications;
transferring the file from the first storage area to a second storage area on a security card;
clearing the first storage area;
determining whether the file is a security risk;
notifying a user that the file is being held in the second storage area;
detecting a user's instruction to accept the file;
if the file is an application file, transferring the file to an application card that is removably disposed in a master read/write slot;
if the file is a data file, transferring the file to a selected memory location; and
clearing the second storage area.

20. The method of claim 19, wherein the user generates the instruction to accept by manipulating a key on a keyboard.

21. The method of claim 19, wherein, if the file is an application file, the method further comprises reestablishing outside communications to verify the authenticity of the file.

22. The method of claim 19, further comprising:
detecting a send signal;
copying a selected file to the second storage area;
detecting a user's instruction to transfer the selected file;
transferring the selected file from the second storage area to the first storage area; and
establishing contact between the communications card and a destination.
